(19) United States
(12) Patent Application Publication
(10) Pub. No.: US 2010/0023373 A1
(43) Pub. Date: Jan. 28, 2010

(54) SYSTEM FOR ENABLING BOTH A SUBJECTIVE AND AN OBJECTIVE EVALUATION OF SUPPLIER PERFORMANCE

(75) Inventors: Aasish Behera, Woodbridge, NJ (US); Mitchell Adam Cohen, Yorktown Heights, NY (US); Jakka Sairamesh, New York, NY (US); Benjamin J. Steele, JR., Newburgh, NY (US); Sai Zeng, Yorktown Heights, NY (US)

Correspondence Address: CANTOR COLBURN LLP-IBM YORKTOWN, 20 Church Street, 22nd Floor, Hartford, CT, 06103, US

(73) Assignee: INTERNATIONAL BUSINESS MACHINES CORPORATION, Armonk, NY (US)

(21) Appl. No.: 12/177,960

(22) Filed: Jul. 23, 2008

(51) Int. Cl. G06Q 10/00

(52) U.S. Cl. 705/10

(57) ABSTRACT

A system to enable a subjective and an objective evaluation of supplier performance is provided and includes a commodity/part/supplier search system, a traceability system, an aggregation system, a survey system, an evaluation system, a scoring system, and an alert system to compare the score with the target performance level of the supplier and, if the score differs from the predicted performance level by a predetermined amount, to alert the supplier of the differential.

### BACKGROUND OF THE INVENTION

1. Field of the Invention

Aspects of the present invention relate to a system for managing supplier evaluation and, more particularly, to a system that enables both a subjective and an objective evaluation of supplier performance.

2. Description of the Background

An enterprise or company relies heavily on their suppliers to deliver products and services on-time, at the right cost and at the right quality level. The success of the suppliers in meeting these goals often has a direct impact on the company's profitability. However, since there are millions of suppliers in the world, effective supplier management processes are needed to gather intelligence on potential suppliers. These processes will allow companies to select and monitor the best suppliers, and to eliminate others. In addition, while a company establishes a partnership with a supplier, a supplier management process may enable the company to develop their capability to improve process capability, to improve delivery schedules, to eliminate avoidable costs and to improve overall efficiency. As such, supplier management processes require evaluation and on-going monitoring of supplier performance.

Current supplier evaluation systems may be characterized into two extreme categories. The first type of supplier evaluation systems includes non-standardized evaluations even for a group of suppliers providing the same products or services. The second type of supplier evaluation systems includes uniform evaluations on a set of fixed criteria and weights regardless of services or goods supplied, criticality to the business, the characteristics of the supplier profile, etc.

In either case, supplier evaluation systems may be primarily concerned about supplier performance from local perspectives. Unfortunately, the visibility of supplier performance information is often limited within the local organizations. Moreover, the supplier evaluations do not tend to include both subjective and objective evaluations. As additional matters, the supplier evaluations may be skewed due to the fact that different managerial levels of a company will have different subjective and/or objective evaluation criteria and the supplier evaluations may become outdated.

Thus, while it is understood that timely awareness of underperforming suppliers is important and necessary to carry out corrective actions and to prevent recurrences, the ability to present evidence of the underperformance along with the awareness of the underperformance is critical and not well presented in the existing supplier evaluation systems.

### SUMMARY OF THE INVENTION

In accordance with an embodiment of the invention, a system to enable a subjective and an objective evaluation of supplier performance is provided and includes a commodity/part/supplier search system to provide for an interface to allow a user to search for commodities, parts and/or suppliers thereof, a traceability system to trace dependencies between the commodities and the parts, processes/operations, changes, and final products associated therewith, and the suppliers and to generate objective and subjective information based on traceability information generated therefrom, an aggregation system to aggregate the objective and subjective information based on the traceability information with objective information relating to the commodities, the parts and/or the suppliers, a survey system to gather information related to a subjective evaluation of the suppliers, an evaluation system to gather and transform the objective and subjective information, the objective and subjective information representing current and past facts and being related to each of the suppliers, a scoring system to analyze the objective and subjective information and to subsequently assign a score to the supplier in accordance with multi-level criteria, weights and scoring functions, and an alert system to compare the score with a target performance level of the supplier and, if the score differs from the target performance level by a predetermined amount, to alert interested parties of the differential.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTIONS OF THE DRAWINGS

The subject matter regarded as the invention is particularly pointed out and distinctly claimed in the claims at the conclusion of the specification. The foregoing and other aspects, features, and advantages of the invention are apparent from the following detailed description taken in conjunction with the accompanying drawings in which:

FIG. 1 is a schematic diagram of a system that enables a subjective and an objective evaluation of supplier performance in accordance with an embodiment of the invention; and

FIG. 2 is a flow diagram illustrating an example process implementation of the system of FIG. 1.

### DETAILED DESCRIPTION OF THE INVENTION

In view of the foregoing, a system in accordance with an embodiment of the present invention enables both a subjective and an objective evaluation of supplier performance so to assess the supplier for supplier qualification and improvement purposes with evaluation criteria that represents subjective and objective measures. To this end, the system polls historical data to provide sufficient evidence for reliable supplier performance evaluation.

The system allows for multi-level aggregation of scoring capability based on an organization and/or stakeholders' needs. A score card records the scoring and provides for a flexibility of defining and using weighted criteria to define relationships as well as allowing for a user defined associated scoring function. An associated scoring function takes one or more data points as an input, and computes a score as an output. These data points could be raw data like a number of defects and average delivery times, or they could be aggregated data. For instance, the data points could be a score for a supplier's delivery performance, a score for a supplier's part quality, etc. Here, the scoring function could be linear, non-linear or step-wise, etc.

The system enables a real-time supplier performance evaluation with real-time availability of information across groups, functions and IT systems boundaries being critical.

The system includes a supplier evaluation system which raises the real-time awareness of non-conformance to the performance criteria. The system automatically generates alerts and communicates rules and evidence. It also provides for flexibility of creating, editing and deleting the alert generation rules.

Thus, it may be seen that the system provides for an evaluation of supplier performance to qualify a supplier as a vendor, to monitor and audit supplier performance, and to enable supplier improvement. The system can be used by various stakeholders in the supplier chain such as a commercial/procurement team and an engineering group. In each case, the stakeholder can leverage existing evaluation criteria in the system or define their own criteria with each criterion having an assigned weight and/or scoring function.

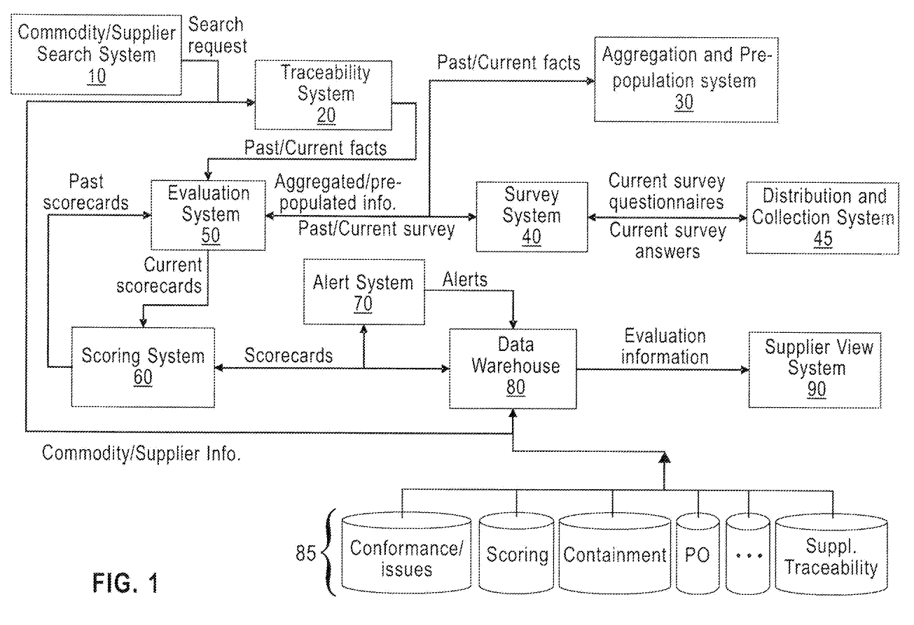

With reference to FIG. 1, the system includes a commodity/supplier search system 10. The commodity/part/supplier search system 10 provides for an interface to allow stakeholders to search for commodities, parts and/or suppliers. In particular, the stakeholder may employ the commodity/supplier search system 10 to search for a particular commodity or part, all parts under a particular commodity, a particular supplier, suppliers associated with a particular commodity or part, or all commodities or parts supplied by a particular supplier.

The traceability system 20 allows for a tracing of the commodities and/or the parts, as well as their associated processes/operations, suppliers, changes, and final products. That is, the traceability system 20 allows for an examination of dependencies between parts, associated processes/operations, suppliers, changes, and final products. This may include examinations of part lifecycles and accounts for the changes in part numbers that may occur over time, identification of parts and their owners, such as designers and suppliers, parts and their suppliers by product lot numbers, revisions to be identified to confirm effectiveness of supplier changes, parts and associated products (for instance, Vehicle Identification Numbers, VINs, on a car), and the parts and the suppliers in a given product

The aggregation and pre-population system 30 allows for an aggregation and pre-population of information relating to parts from multiple sources, such as various projects, and various product models and geographic locations. For instance, one metric which is crucial to supplier quality and which is related to a particular part is the number of defects associated with the part measured in parts per million (PPM). Here, while the traceability system 20 traces the parts supplied by a particular supplier for all possible product models, the aggregation and pre-population system 30 aggregates the number of parts supplied and the numbers of defects that occur.

The survey system 40 gathers input from stakeholders on supplier performance, supplied service and/or the quality of goods supplied and is, generally, the mechanism by which the subjective metrics (e.g., those metrics that measure intangibles like trust, confidence, attitudes and satisfaction) are gathered. Example stakeholders are clients or users who consume the supplied services or goods, procurement personnel, heavy users and/or global clients.

In an embodiment of the survey system 40, survey questions, criteria, business rules, weights and scoring functions can be flexibility defined. Once stakeholders are identified, and appropriate questionnaires are finalized, a survey distribution system 45, which is coupled to the survey system 40, automatically communicates the surveys to the stakeholders. The survey distribution system 45 is also responsible for collecting inputs from responses.

The evaluation system 50 is used to prepare inputs for the scoring system 60 after all the necessary information is gathered from the various systems. The input includes objective and subjective information from supply chain processes, manufacturing processes, and warranty and service processes. This set of information represents current and past facts.

The scoring system 60 is a core component and allows for an identification of the best suppliers for specific parts and/or commodities to allow for supplier selection processes to occur. The scoring system 60 also allows for an identification of under performing suppliers on an overall, part, or commodity level to allow for supplier improvement processes to be initiated. The above-noted identifications are based on the scores computed from multi-level criteria, weights, and scoring functions.

According to various embodiments of the invention, a score card (not shown) is designed for use with the scoring system 60. The score card may be customized so as to be relatively easily implemented and to allow users the freedom to create, edit and delete the score card's criteria, weights, and scoring functions.

The alert system 70 monitors business events and warns of abnormal behavior. Using rules for business events (e.g., a threshold number of failures for a specific part during a particular duration) the alert system 70 alerts users when the rules have been violated based on the metrics calculated for the rules.

A data warehouse 80 consolidates supplier performance data sources throughout the product lifecycle. Example data sources shown in FIG. 1 come from systems measuring conformance, issue management, containment, purchase orders, and warranty spanning supply chain processes, manufacturing processes and service and warranty processes 85. The data warehouse 80, therefore, contains specialized summary tables (not shown) to limit the need for repetitive calculations and contains dimensions to allow for processing based on any combination of parts, suppliers, plants, and programs, etc.

The supplier view system 90 provides for visibility of the information related to the performance evaluation. In that way, the supplier view system may be embodied as a user interface to be presented in a computing environment.

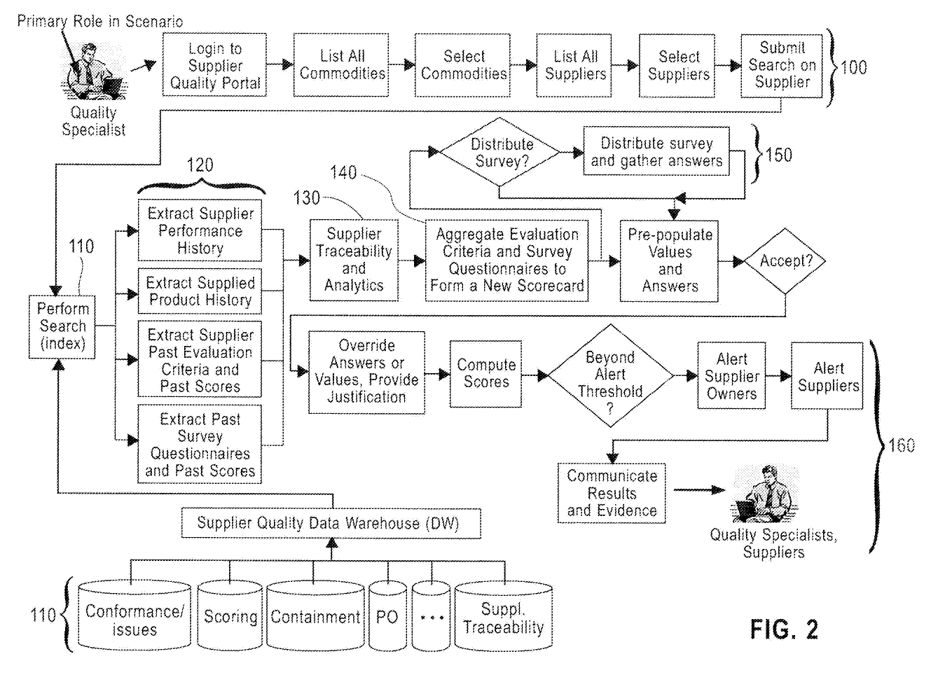

With reference to FIG. 2, a flow diagram illustrates an example process implementation of the system discussed above. As shown, a user initially logs into a supplier quality portal by which the user accesses the system. The user then lists all commodities that he is interested in and selects at least one commodity to research. The system then displays all of the suppliers that supply and/or make the selected commodity and the user selects at least one of the suppliers (operation 100).

At this point, a search of the selected supplier is begun, with the search taking as its inputs data from the data warehouse 80 (operation 110). As part of the search, the supplier performance history, the supplied product history, the past supplier evaluations and the past supplier questionnaires are extracted (operation 120). Results of the search are then analyzed in a supplier traceability and analytics stage (operation 130) during which examinations of any dependencies between the selected supplier(s) and the selected part(s) are conducted.

At this point, evaluation criteria and survey questionnaires are aggregated to form a new scorecard based on current available data (operation 140). This scorecard may be selectively amended, however, in accordance with newly submitted survey responses received via the survey system (operation 150). Once the scorecard is accepted, scores for the supplier are computed and it is determined whether an alert needs to be sent to the interested parties (e.g. supplier owners, suppliers) for supplier underperformance (operation 160).

In accordance with another aspect of the invention, the methods described above may be embodied in a machine implemented computer readable medium having instructions stored thereon to execute the methods.

While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular exemplary embodiment disclosed as the best mode contemplated for carrying out this disclosure, but that the disclosure will include all embodiments falling within the scope of the appended claims.

1. A system to enable a subjective and an objective evaluation of supplier performance, the system comprising:
a commodity/part/supplier search system to provide for an interface to allow a user to search for commodities, parts and/or suppliers thereof;
a traceability system to trace dependencies between the commodities and the parts, processes/operations, changes, and final products associated therewith, and the suppliers and to generate objective and subjective information based on traceability information generated therefrom;
an aggregation system to aggregate the objective and subjective information based on the traceability information with objective information relating to the commodities, the parts and/or the suppliers;
a survey system to gather information related to a subjective evaluation of the suppliers;
an evaluation system to gather and transform the objective and subjective information, the objective and subjective information representing current and past facts and being related to each of the suppliers;
a scoring system to analyze the objective and subjective information and to subsequently assign a score to the supplier in accordance with multi-level criteria, weights and scoring functions; and
an alert system to compare the score with a target performance level of the supplier and, if the score differs from the target performance level by a predetermined amount, to alert interested parties of the differential.

2. The system according to claim 1, further comprising a survey distribution system, which is coupled to the survey system, to automatically communicate surveys to users by which the information to be gathered is generated.

3. The system according to claim 1, wherein the evaluation system gathers information related to supplier chain processes, manufacturing processes, and warranty and service processes.

4. The system according to claim 1, wherein the scoring system identifies an underperforming and/or over achieving supplier.
